(19) United States
(12) Patent Application Publication
(10) Pub. No.: US 2025/0173097 A1
(43) Pub. Date: May 29, 2025

(54) DISPLAY OPERATION DEVICE AND IMAGE FORMING APPARATUS INCLUDING DISPLAY OPERATION DEVICE

(71) Applicant: SHARP KABUSHIKI KAISHA, Sakai City (JP)

(72) Inventor: KENJI ITOH, Sakai City (JP)

(21) Appl. No.: 18/953,383

(22) Filed: Nov. 20, 2024

(30) Foreign Application Priority Data
Nov. 24, 2023 (JP) 2023-199264

(51) Int. Cl. G06F 3/12; G06F 3/04847; G06F 3/0488; H04N 1/00

(52) U.S. Cl. CPC G06F 3/1208; G06F 3/04847; G06F 3/0488; G06F 3/1204; G06F 3/1254; H04N 1/0044

(57) ABSTRACT

To provide a display operation device including an operation acceptor that receives an operation performed by a user, a display that displays, to the user, a setting screen for a job, and one or more controllers that control the operation acceptor and the display. The setting screen has a setting button that is used to receive a setting operation performed by the user and display a setting of the setting operation received, and a job start button that receives an operation performed by the user to start the job is composed of a plurality of the setting buttons.

### BACKGROUND OF THE INVENTION

### Field of the Invention

The present disclosure relates to a display operation device, and an image forming apparatus including the display operation device.

### Description of the Background Art

Image forming apparatuses that form an image in an image forming mode such as a two-color mode in which an image is formed using two colors or a monochrome mode are conventionally known.

Image formation in such a two-color image forming mode requires selection and setting in advance of two colors, color densities, and the like.

However, in some cases, after an image is actually printed, the printed image is difficult to see and unclear due to the settings of two colors.

In order to solve such a problem, a scan-in function in which a preview screen is displayed under set conditions, a trial copy function in which only a single copy is first printed for content check, and the like are conventionally proposed.

However, when a setting error is found before printing, a user needs to display a setting screen again and perform setting. Furthermore, the settings cannot be changed immediately when an unclear image is printed based on the set color selection and densities.

The present disclosure has been made in view of the above circumstances, and an object of the present disclosure is to provide a display operation device that allows easier confirmation of a job setting before the job is started than a conventional display operation device and provides high user convenience.

### SUMMARY OF THE INVENTION

A display operation device according to the present disclosure is a display operation device including: an operation acceptor that receives an operation performed by a user; a display that displays, to the user, a setting screen for a job; and one or more controllers that control the operation acceptor and the display, wherein the setting screen has a setting button that is used to receive a setting operation performed by the user and display a setting of the setting operation received, and a job start button that receives an operation performed by the user to start the job is composed of a plurality of the setting buttons.

The present disclosure achieves a display operation device in which a setting screen displays a job start button composed of setting buttons on which information indicating various job settings is displayed and that thus allows easier confirmation of the job settings than a conventional display operation device and provides high user convenience.

### BRIEF DESCRIPTION OF THE DRAWINGS

FIG. 1 is a perspective view of an external appearance of a digital multifunction machine of the present disclosure.

FIG. 2 is a block diagram schematically illustrating a configuration of the digital multifunction machine shown in FIG. 1.

FIG. 3 is an explanatory diagram showing an example of a two-color copy setting screen of the digital multifunction machine shown in FIG. 1.

FIG. 4 is a flowchart showing an example of a two-color printing process performed by the digital multifunction machine shown in FIG. 1.

FIGS. 5A and 5B are explanatory diagrams showing an example of a color setting change on a two-color printing screen of the digital multifunction machine shown in FIG. 1.

FIG. 6 is an explanatory diagram showing an example of a two-color copy setting screen of a digital multifunction machine according to Embodiment 2 of the present disclosure.

FIG. 7 is a flowchart showing an example of a two-color printing process performed by the digital multifunction machine according to Embodiment 2 of the present disclosure.

FIGS. 8A and 8B are explanatory diagrams showing an example of a color setting change on a two-color printing screen of the digital multifunction machine according to Embodiment 2 of the present disclosure.

FIG. 9 is an explanatory diagram showing an example of a copy setting screen of a digital multifunction machine according to Embodiment 3 of the present disclosure.

FIG. 10 is a flowchart showing an example of a printing process performed by the digital multifunction machine according to Embodiment 3 of the present disclosure.

FIGS. 11A and 11B are explanatory diagrams showing an example of a function setting change on a printing screen of the digital multifunction machine according to Embodiment 3 of the present disclosure.

FIG. 12 is an explanatory diagram showing an example of a copy setting screen of a digital multifunction machine according to Embodiment 4 of the present disclosure.

### DESCRIPTION OF THE PREFERRED EMBODIMENTS

In the present disclosure, the “display operation device” is a device that displays various types of information to a user and displays an operation screen (user interface) on which a command from the user is received.

The “information indicating a setting associated with the setting button” for an image forming job such as copying may be information indicating a color in color setting, a density in density setting, single-sided or double-sided printing in single-sided/double-sided printing setting for the copying, or the like.

Furthermore, preferred aspects of the present disclosure will be described.

In the display operation device according to the present disclosure, when the operation acceptor receives a predetermined first operation of one of the setting buttons, the one or more controllers may cause the display to display a setting change screen on which a change in setting associated with the one of the setting buttons is received.

The operation of causing “the display to display a setting change screen on which a change in setting associated with the one of the setting buttons is received” may be, for example, display of the setting change screen as a pop-up, or the like.

This makes it possible to achieve a display operation device in which when a predetermined first operation of a setting button is performed, a setting screen related to a setting associated with the setting button is displayed by a display to perform setting and that thus provides high user convenience.

In the display operation device according to the present disclosure, the first operation may be a predetermined swipe operation of the one of the setting buttons.

The “predetermined swipe operation of the one of the setting buttons” may be, for example, when the job start button is composed of left and right setting buttons, a swipe operation of one of the left and right setting buttons in the vertical direction.

This makes it possible to achieve a display operation device in which when a predetermined swipe operation of a setting button is performed, a setting screen related to a setting associated with the setting button is displayed by a display to perform setting and that thus provides high user convenience.

In the display operation device according to the present disclosure, the display operation device may further include a timer that measures predetermined determination time, and the first operation may be a long-press operation of the one of the setting buttons for the determination time or more.

This makes it possible to achieve a display operation device in which when a predetermined long-press operation of a setting button is performed, a setting screen related to a setting associated with the setting button is displayed by a display to perform setting and that thus provides high user convenience.

In the display operation device according to the present disclosure, when the operation acceptor receives a predetermined second operation of one of the setting buttons, the one or more controllers may cause a job to be performed according to a setting associated with the one of the setting buttons.

This makes it possible to achieve a display operation device in which when a predetermined second operation of a setting button is performed, a job is performed according to a setting associated with the setting button and that thus provides high user convenience.

In the display operation device according to the present disclosure, the display operation device may further include a timer that measures predetermined determination time, and the second operation may be a short-press operation of the one of the setting buttons for less than the predetermined determination time.

This makes it possible to achieve a display operation device in which when a predetermined short-press operation of a setting button is performed, a job is performed according to a setting associated with the setting button and that thus provides high user convenience.

An image forming apparatus according to the present disclosure is an image forming apparatus including: the display operation device; and an image former that performs image formation based on a print execution command received by the operation acceptor, wherein the display displays, to the user, a setting screen related to the image formation, and the setting screen includes an image formation start button composed of a plurality of setting buttons associated with various respective predetermined image formation settings.

In the present disclosure, the “image forming apparatus” is an apparatus that forms an image and outputs the image, such as a copier or multifunction device having a copying (copy) function such as a printer using an electrophotographic method to form an image with toner, or a multifunctional peripheral (MFP) also having a function other than the copying function.

This makes it possible to achieve an image forming apparatus in which a setting screen displays an image formation start button composed of setting buttons on which information indicating various image formation settings is displayed and that thus allows easier confirmation of the image formation settings than a conventional image forming apparatus and provides high user convenience.

The present disclosure will be described below in more detail with reference to the drawings. The following description is illustrative in all respects and should not be construed as limiting the present disclosure.

### Embodiment 1

### Configuration of Digital Multifunction Machine 1

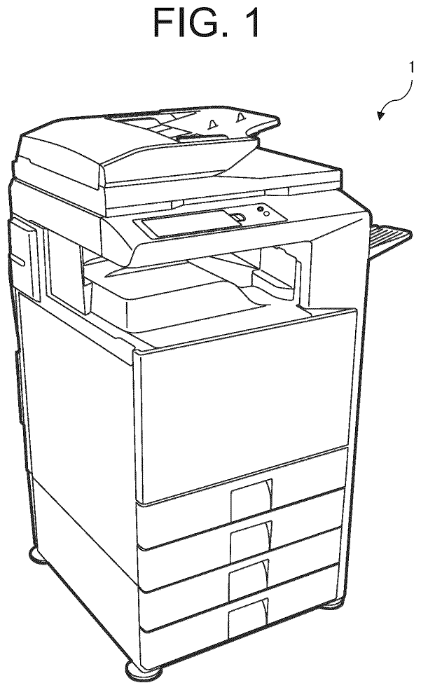

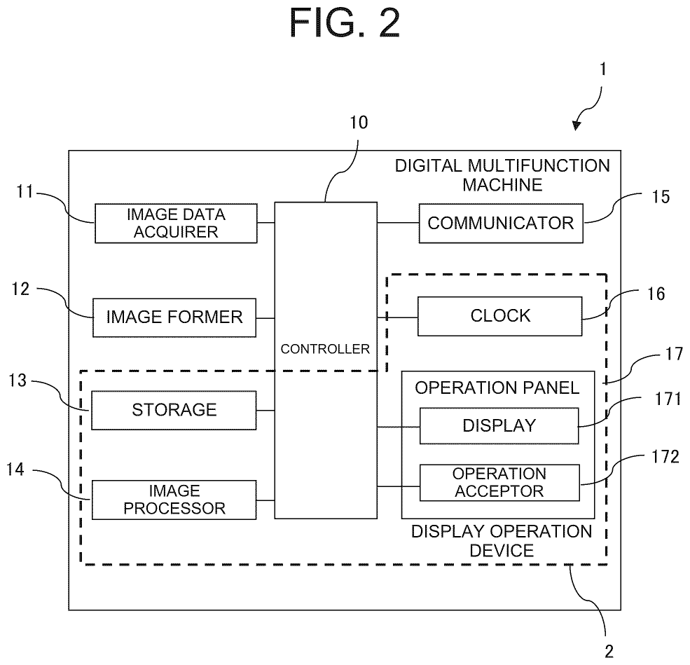

A configuration of a digital multifunction machine 1 as an example of a display operation device and an image forming apparatus including the display operation device according to Embodiment 1 of the present disclosure will be described below with reference to FIGS. 1 and 2.

FIG. 1 is a perspective view of an external appearance of a digital multifunction machine of the present disclosure.

FIG. 2 is a block diagram schematically illustrating a configuration of the digital multifunction machine shown in FIG. 1.

The digital multifunction machine 1 has a copy function, a scanner function, and a facsimile function, and digitally processes image data read from a document and outputs the processed image data.

As shown in FIG. 2, the digital multifunction machine 1 includes a controller 10, an image data acquirer 11, an image former 12, a storage 13, an image processor 14, a communicator 15, a clock 16, and an operation panel 17.

In FIG. 2, a display operation device 2 according to Embodiment 1 of the present disclosure is composed of the storage 13, the image processor 14, the clock 16, and the operation panel 17.

The components of the digital multifunction machine 1 will be described below.

The controller 10 integrally controls the digital multifunction machine 1, and is composed of at least one central processing unit (CPU), a random-access memory (RAM), a read only memory (ROM), various interface circuits, and the like.

In order to control the operation of the entire digital multifunction machine 1, the controller 10 monitors and controls detection by sensors and all loads such as a motor, a clutch, and the operation panel 17.

The image data acquirer 11 detects and reads a document placed on a document placement table or a document conveyed from a paper tray to acquire image data.

The image data acquirer 11 may acquire image data from an external user terminal via a communicator (not shown).

The image former 12 prints and outputs, on a recording medium, image data generated by the image processor 14.

The storage 13 is an element or storage medium that stores information required to implement various functions of the digital multifunction machine 1, a control program, and the like. The storage 13 may be, for example, a storage medium such as a semiconductor device such as a RAM or a ROM, a hard disk, a flash storage, or a solid-state drive (SSD).

A program and data may be held in different devices such that an area for holding the data is composed of a hard disk drive and an area for holding the program is composed of a flash storage.

The image processor 14 converts an image of the document read by the image data acquirer 11 into an appropriate electrical signal to generate image data.

In particular, when two-color copying is performed, the image processor 14 converts image data on the document based on two colors that have been set.

The communicator 15 communicates with a computer, a mobile information terminal, an external information processing apparatus, a facsimile machine, or the like via a network or the like, and transmits and receives various types of information such as an e-mail and a facsimile to and from such an external communication device.

The clock 16 is a timer that acquires the time through an internal clock or a network, and measures and counts time.

In Embodiment 1, the clock 16 measures predetermined determination time, and the controller 10 determines whether a setting button constituting a two-color copy start button has been subjected to a long-press operation for the determination time (e.g., 2 seconds) or more or a short-press operation for less than the determination time.

The operation panel 17 is composed of a display panel composed of a liquid crystal panel or the like, and a touch panel that overlaps with the display panel and uses, for example, a capacitive method to detect the position of a finger touch. The operation panel 17 includes a display 171 and an operation acceptor 172.

The display 171 displays various types of information and receives a command from the user using a touch panel function.

The display 171 is composed of, for example, a CRT display, a liquid crystal display, an EL display, or the like, and is a display device such as a monitor or line display for an operating system or application software to display electronic data on a processing state or the like. The controller 10 displays the operation and state of the digital multifunction machine 1 using the display 171.

The operation acceptor 172 is an interface used to operate the digital multifunction machine 1, and receives a command from the user.

Two-color copying process performed by digital multifunction machine 1 according to Embodiment 1 of the present disclosure

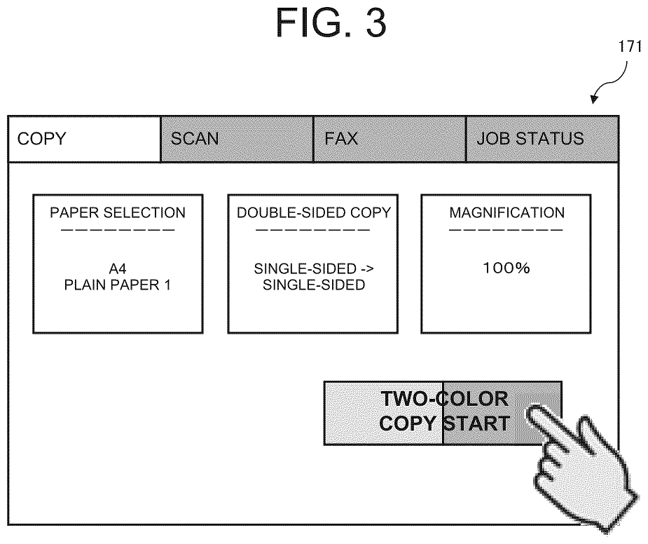

Next, an example of a two-color copying process performed by the digital multifunction machine 1 according to Embodiment 1 of the present disclosure will be described with reference to FIGS. 3 to 5.

When copying is performed, for a variety of functions such as two-color copying in which printing only in two colors is performed, reduction copying in which an A4-size document is reduced and printed on B4-size paper, enlargement copying in which a B4-size document is enlarged and printed on A4-size paper, and double-sided copying, the user sets various functions on setting screens and presses a print start button to start printing.

However, in some cases, the user overlooks a setting error and presses the print start button to perform printing, and then the setting error is detected, resulting in waste of printed matter. In particular, when two-color copying is performed, due to various color combinations, the obtained printed matter may be different from what is expected by the user, and for example, the color combination of the printed matter may be difficult to see.

In the present disclosure, in order to reduce such a problem, before the print start button is pressed to perform printing, color information set to the print start button is displayed and visualized as follows.

FIG. 3 is an explanatory diagram showing an example of a two-color copy setting screen of the digital multifunction machine 1 shown in FIG. 1.

In FIG. 3, a “two-color copy start” button is composed of two left and right setting buttons.

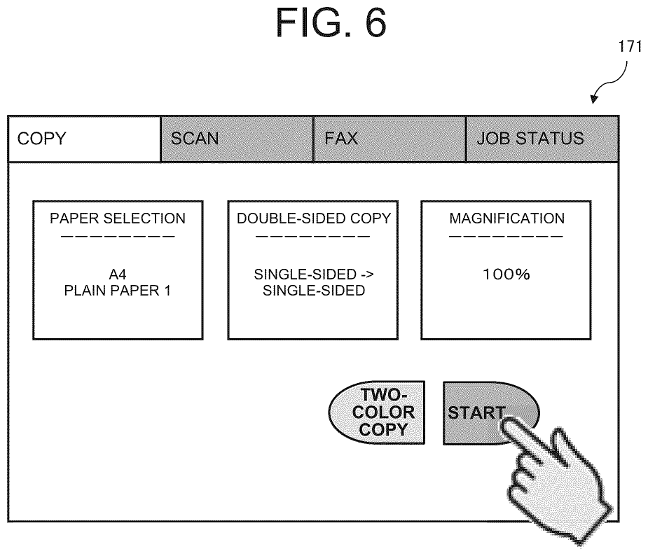

The setting buttons constituting the start button may not necessarily be physically in close contact with each other, and may be separated to some extent from each other when, as shown in FIG. 6, it is clear that a plurality of setting buttons collectively constitute the start button.

In the present disclosure, a plurality of setting buttons constitute the start button.

The setting buttons are each colored in the same color as the color in the color setting associated with the corresponding setting button as information indicating the settings of colors for two-color printing. In the example in FIG. 3, the right setting button is displayed in magenta, and the left setting button is displayed in cyan.

The “two-color copy start” button having the above configuration allows the user to check whether the settings of two colors are correct, whether the color arrangement is not difficult to see, or the like, before the user presses the button.

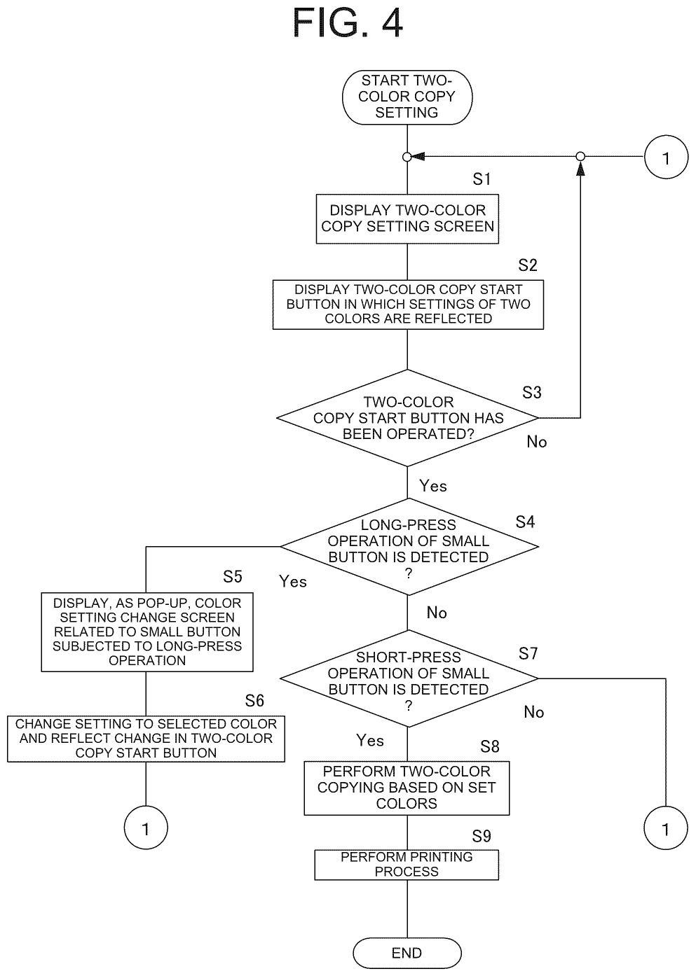

FIG. 4 is a flowchart showing an example of a two-color printing process performed by the digital multifunction machine 1 shown in FIG. 1.

When the user starts two-color copy setting, in step S1 in FIG. 4, the controller 10 of the digital multifunction machine 1 displays the two-color copy setting screen (step S1).

Next, in step S2, as shown in FIG. 3, the controller 10 displays a two-color copy start button in which the settings of two colors are reflected (step S2).

For example, when the color setting of the right setting button is magenta and the color setting of the left setting button is cyan, the right setting button and the left setting button are displayed in magenta and cyan, respectively.

Next, in step S3, the controller 10 determines whether the two-color copy start button has been operated (step S3).

When the two-color copy start button has not been operated (when the answer is determined to be No in step S3), the controller 10 returns the processing to step S1.

On the other hand, when the two-color copy start button has been operated (when the answer is determined to be Yes in step S3), in step S4, the controller 10 determines whether a long-press operation of any of the setting buttons constituting the two-color copy start button is detected (step S4).

For example, when one of the left and right setting buttons is continuously pressed for 2 seconds or more, the controller 10 determines that a long-press operation of the one of the setting buttons has been performed.

When a long-press operation of any of the setting buttons is detected (when the answer is determined to be Yes in step S4), in step S5, the controller 10 causes the display 171 to display, as a pop-up, a color setting change screen associated with the setting button subjected to the long-press operation (step S5).

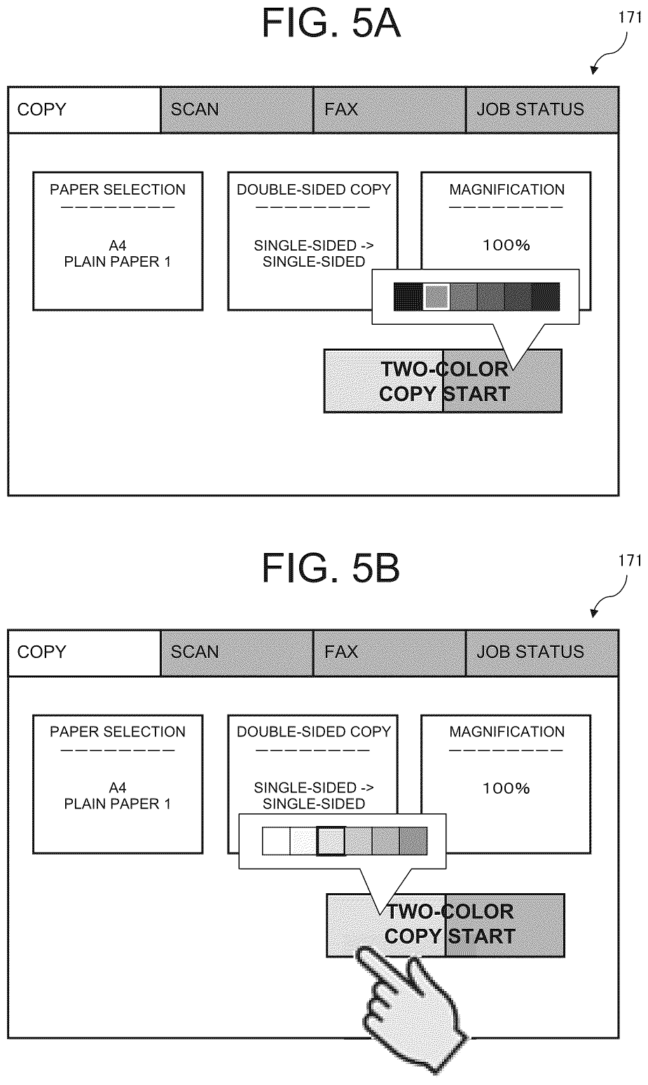

FIGS. 5A and 5B are an explanatory diagrams showing an example of a color setting change on a two-color printing screen of the digital multifunction machine 1 shown in FIG. 1.

FIG. 5A shows an example in which in response to a long-press operation of the right setting button performed by the user, a color setting change screen for the color associated with the right setting button is displayed as a pop-up.

FIG. 5B shows an example in which in response to a long-press operation of the left setting button performed by the user, a color setting change screen for the color associated with the left setting button is displayed as a pop-up.

The operation performed to display the setting change screen as a pop-up is not limited to the long-press operation, and may be, for example, an operation such as double-clicking or tapping with two or more fingers.

FIGS. 5A and 5B show only the example in which the color is changed to colors of the same type such as magenta or cyan; however, the screen may include an option in which the color can be changed to colors of different types such as yellow, monochrome, or RGB.

The user can select a desired color on the color setting change screen displayed as a pop-up to change the color associated with each of the left and right setting buttons.

The setting change screen displayed as a pop-up may be hidden after a lapse of a predetermined time.

Next, in step S6 in FIG. 4, the controller 10 changes the setting to the selected color, and reflects the changed color information in the two-color copy start button (step S6). Then, the controller 10 returns the processing to step S1.

On the other hand, when in step S4, no long-press operation of the setting buttons is detected (when the answer is determined to be No in step S4), in step S7, the controller 10 determines whether a short-press operation of any of the setting buttons is detected (step S7).

When no short-press operation of the setting buttons is detected (when the answer is determined to be No in step S7), the controller 10 returns the processing to step S1.

On the other hand, when a short-press operation of any of the setting buttons is detected (when the answer is determined to be Yes in step S7), in step S8, the controller 10 causes the image processor 14 to perform two-color copying based on the set colors (step S8).

In subsequent step S9, the controller 10 causes the image former 12 to perform a printing process (step S9), and then ends the process.

### Modification of Embodiment 1

As a modification of Embodiment 1, when the digital multifunction machine 1 receives a print command from an external user terminal, a two-color copy start button may be displayed on a setting screen of a printer driver or the like of the user terminal.

This makes it possible to achieve the digital multifunction machine 1 in which for two-color copying, a print setting button displays a print start button composed of setting buttons on which information indicating various print settings is displayed and when a long-press operation of one of the setting buttons is performed, a print setting screen related to a print setting associated with the one of the setting buttons is displayed by the display 171 to perform setting and that thus allows easier confirmation of the print settings than a conventional digital multifunction machine and provides high user convenience.

### Embodiment 2

Two-color copying process performed by digital multifunction machine 1 according to Embodiment 2 of the present disclosure

Next, an example of a two-color copying process performed by the digital multifunction machine 1 according to Embodiment 2 of the present disclosure will be described with reference to FIGS. 6 to 8.

A configuration of the digital multifunction machine 1 of Embodiment 2 is the same as that of the digital multifunction machine 1 of Embodiment 1 (FIG. 2), and thus description thereof is omitted.

FIG. 6 is an explanatory diagram showing an example of a two-color copy setting screen of the digital multifunction machine 1 according to Embodiment 2 of the present disclosure. As in FIG. 3, also in FIG. 6, a two-color copy start button is composed of left and right setting buttons (left setting button and right setting button), and the setting buttons are each colored in the same color as the color for the two-color printing of the corresponding setting button.

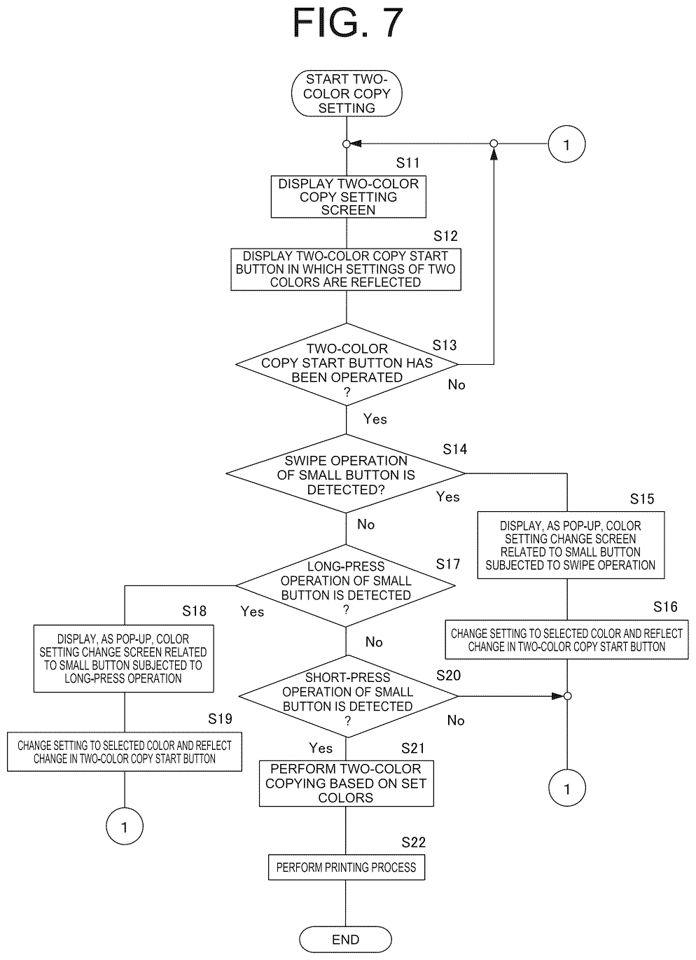

FIG. 7 is a flowchart showing an example of a two-color printing process performed by the digital multifunction machine 1 according to Embodiment 2 of the present disclosure.

Steps S11 to S13 and S17 to S22 in FIG. 7 correspond to steps S1 to S9 in FIG. 4 (Embodiment 1), respectively, and thus description thereof is omitted.

Processing in steps S14 to S16 in FIG. 7 different from the processing in Embodiment 1 is described below.

In step S13 in FIG. 7, when the two-color copy start button has been operated (when the answer is determined to be Yes in step S13), in step S14, the controller 10 determines whether a swipe operation of any of the setting buttons is detected (step S14).

When no swipe operation of the setting buttons is detected (when the answer is determined to be No in step S14), the controller 10 performs determination in step S17.

On the other hand, when a swipe operation of any of the setting buttons is detected (when the answer is determined to be Yes in step S14), in step S15, the controller 10 causes the display 171 to display, as a pop-up, a color setting change screen associated with the setting button subjected to the swipe operation (step S15).

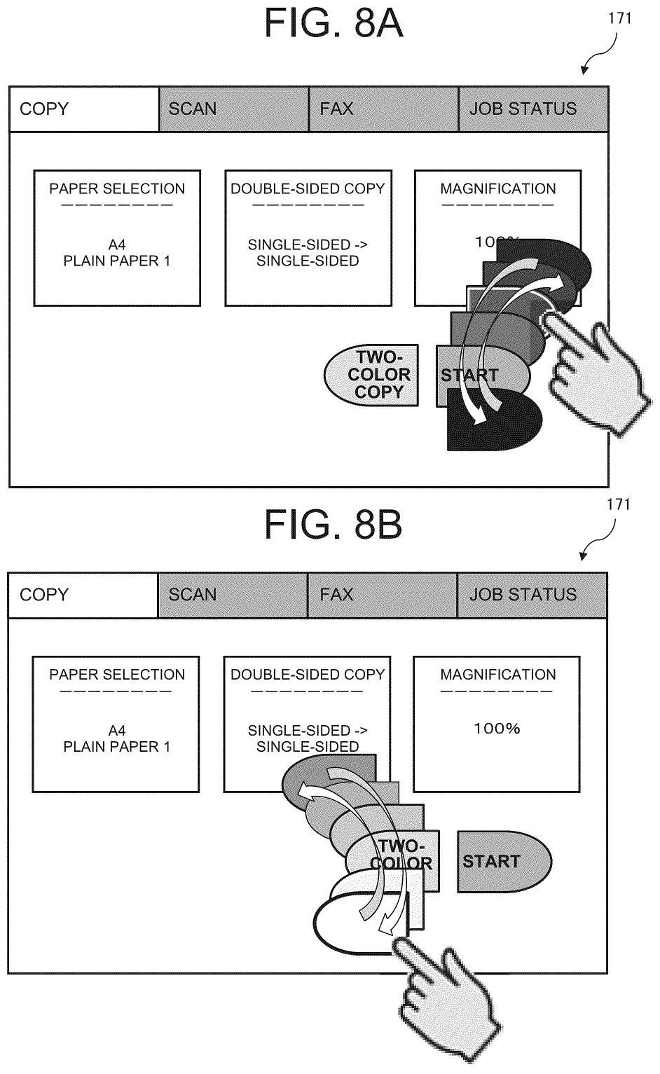

FIGS. 8A and 8B are explanatory diagrams showing an example of a color setting change on a two-color printing screen of the digital multifunction machine according to Embodiment 2 of the present disclosure.

FIG. 8A shows an example in which in response to a swipe operation of the right setting button in the vertical direction performed by the user, a color setting change screen for the color associated with the right setting button is displayed as a pop-up.

FIG. 8B shows an example in which in response to a swipe operation of the left setting button in the vertical direction performed by the user, a color setting change screen for the color associated with the left setting button is displayed as a pop-up.

The user can select a desired color on the color setting change screen displayed as a pop-up to change the color associated with each of the left and right setting buttons.

Next, in step S16 in FIG. 7, the controller 10 changes the setting to the selected color, and reflects the changed color information in the two-color copy start button (step S16). Then, the controller 10 returns the processing to step S11.

This makes it possible to achieve the digital multifunction machine 1 in which for two-color copying, a print setting button displays a print start button composed of setting buttons on which information indicating various print settings is displayed and when a swipe operation of one of the setting buttons is performed, a print setting screen related to a print setting associated with the one of the setting buttons is displayed by the display 171 to perform setting and that thus allows easier confirmation of the print settings than a conventional digital multifunction machine and provides high user convenience.

### Embodiment 3

Copying process performed by digital multifunction machine 1 according to Embodiment 3 of the present disclosure

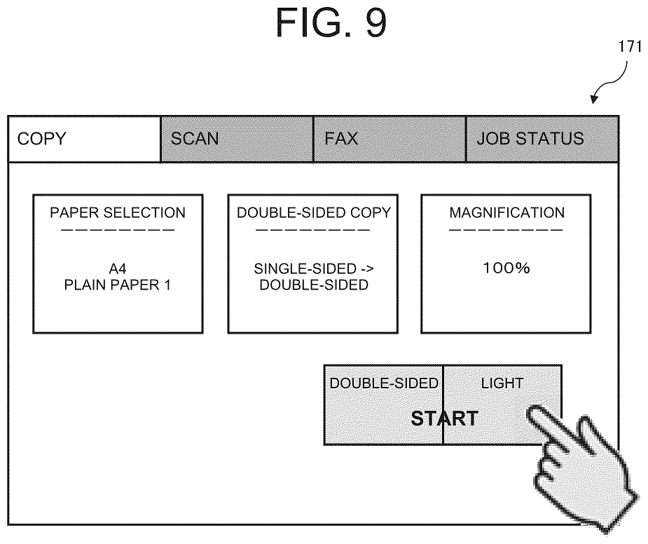

Next, an example of a copying process performed by the digital multifunction machine 1 according to Embodiment 3 of the present disclosure will be described with reference to FIGS. 9 to 11.

A configuration of the digital multifunction machine 1 of Embodiment 3 is the same as that of the digital multifunction machine 1 of Embodiment 1 (FIG. 2), and thus description thereof is omitted.

FIG. 9 is an explanatory diagram showing an example of a copy setting screen of the digital multifunction machine 1 according to Embodiment 3 of the present disclosure.

In FIG. 9, a “start” button is composed of a right setting button on which a density setting is displayed and a left setting button on which a single-sided/double-sided setting is displayed.

In the example in FIG. 9, “light” is displayed on the right setting button and “double-sided” is displayed on the left setting button; thus, the user can confirm at a glance that the double-sided setting and the light setting have been performed.

As shown in the example in FIG. 9, the “start” button colored with a selected density allows the user to confirm the density setting at a glance.

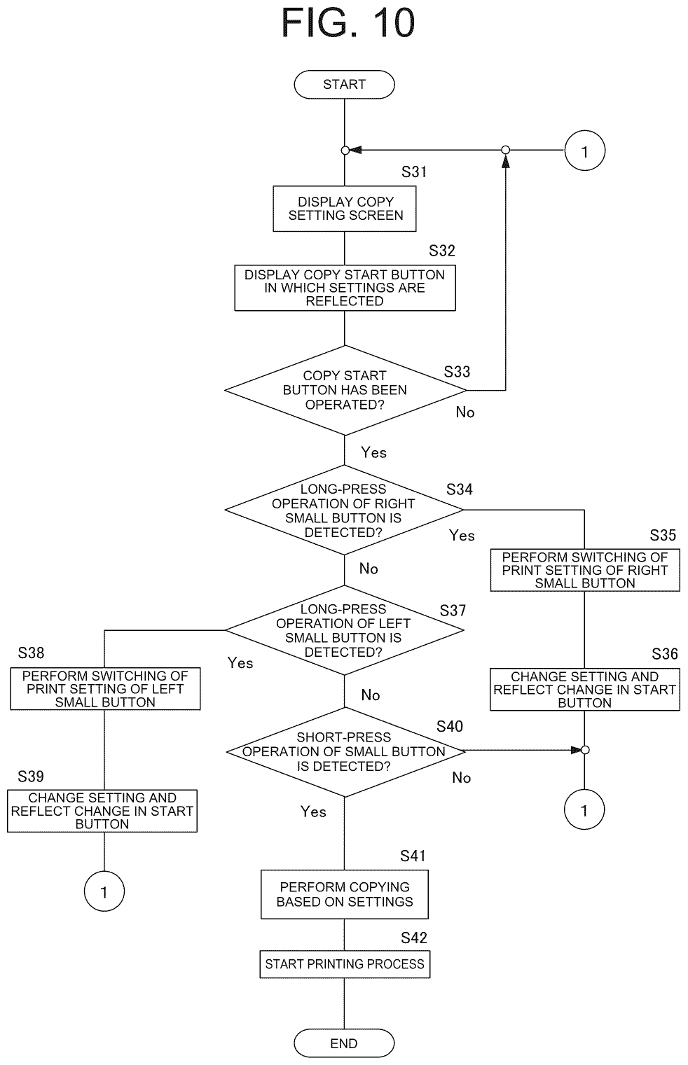

FIG. 10 is a flowchart showing an example of a printing process performed by the digital multifunction machine 1 according to Embodiment 3 of the present disclosure.

When the user starts two-color copy setting, in step S31 in FIG. 10, the controller 10 of the digital multifunction machine 1 displays the copy setting screen (step S31).

Next, in step S32, as shown in FIG. 9, the controller 10 displays a copy start button in which two predetermined settings are reflected (step S32).

Other than the density setting and the single-sided/double-sided setting, such settings include settings of monochrome/color, the number of copies, magnification, paper tray, and paper size.

Next, in step S33, the controller 10 determines whether the copy start button has been operated (step S33).

When the copy start button has not been operated (when the answer is determined to be No in step S33), the controller 10 returns the processing to step S31.

On the other hand, when the copy start button has been operated (when the answer is determined to be Yes in step S33), in step S34, the controller 10 determines whether a long-press operation of the right setting button is detected (step S34).

When a long-press operation of the right setting button is detected (when the answer is determined to be Yes in step S34), in step S35, the controller 10 performs switching of a print setting associated with the right setting button subjected to the long-press operation (step S35).

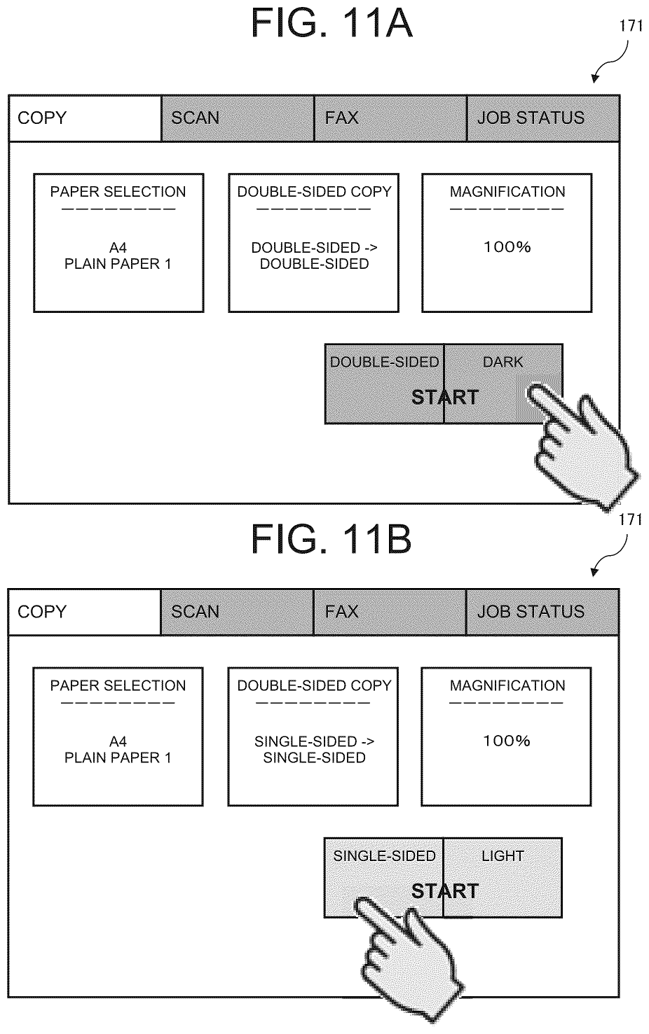

FIGS. 11A and 11B are explanatory diagrams showing an example of a function setting change on a printing screen of the digital multifunction machine 1 according to Embodiment 3 of the present disclosure.

FIG. 11A shows an example in which in response to a long-press operation of the right setting button performed by the user, the density setting associated with the right setting button has been switched from “light” to “dark”.

The setting may be sequentially switched between three or more states each time a long-press operation of the setting button is performed.

Next, in step S37 in FIG. 10, the controller 10 determines whether a long-press operation of the left setting button is detected (step S37).

When a long-press operation of the left setting button is detected (when the answer is determined to be Yes in step S37), in step S38, the controller 10 performs switching of a print setting associated with the left setting button subjected to the long-press operation (step S38).

FIG. 11B shows an example in which in response to a long-press operation of the left setting button performed by the user, the single-sided/double-sided setting associated with the left setting button has been switched from “double-sided” to “single-sided”.

Next, in step S39 in FIG. 10, the controller 10 changes the setting to the selected state, and reflects the change in the copy start button (step S39).

Then, the controller 10 returns the processing to step S31.

On the other hand, when in step S37, no long-press operation of the left setting buttons is detected (when the answer is determined to be No in step S37), in step S40, the controller 10 determines whether a short-press operation of any of the left and right setting buttons is detected (step S40).

When no short-press operation of the setting buttons is detected (when the answer is determined to be No in step S40), the controller 10 returns the processing to step S31.

On the other hand, when a short-press operation of any of the setting buttons is detected (when the answer is determined to be Yes in step S40), in step S41, the controller 10 causes the image processor 14 to perform copying based on the settings (step S41).

In subsequent step S42, the controller 10 causes the image former 12 to perform a printing process (step S42), and then ends the process.

This makes it possible to achieve the digital multifunction machine 1 in which a print setting button displays a print start button composed of setting buttons on which information indicating various print settings is displayed and when a long-press operation of one of the setting buttons is performed, a print setting screen related to a print setting associated with the one of the setting buttons is displayed by the display 171 to perform setting.

### Embodiment 4

Copy setting screen of digital multifunction machine 1 according to Embodiment 4 of the present disclosure

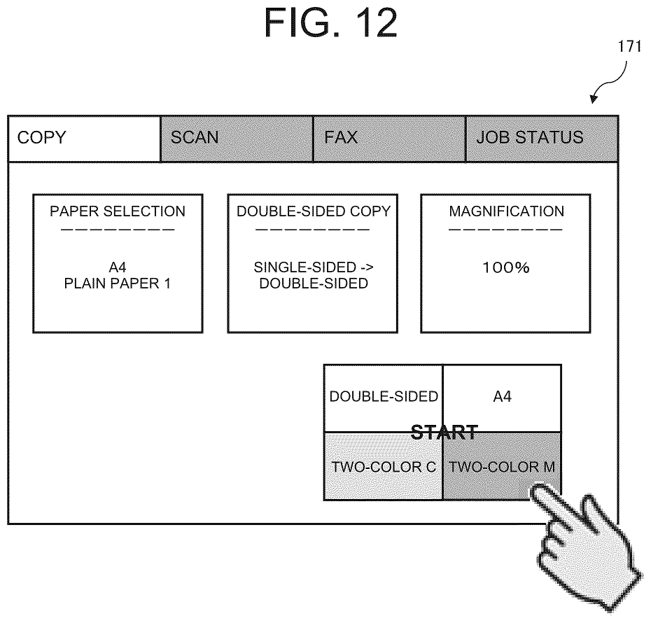

Next, an example of a copy setting screen of the digital multifunction machine 1 according to Embodiment 4 of the present disclosure will be described with reference to FIG. 12.

FIG. 12 is an explanatory diagram showing an example of a copy setting screen of the digital multifunction machine according to Embodiment 4 of the present disclosure.

In FIG. 12, a “start” button is composed of four setting buttons: an upper left button, an upper right button, a lower left button, and a lower right button.

In the example in FIG. 12, “double-sided” is displayed on the upper left setting button, “A4” is displayed on the upper right setting button, “two-color C (cyan)” is displayed on the lower left setting button, and “two-color M (magenta)” is displayed on the lower right setting button; thus, the user can confirm at a glance the setting content of the setting buttons.

The number of setting buttons constituting the “start” button is not limited to two or four, and the “start” button may be composed of an arbitrary number of setting buttons.

When the number of setting buttons is increased or decreased, the size of the start button may be changed as appropriate according to the number of setting buttons.

These settings are changed in the same manner as in Embodiments 1 to 3.

This makes it possible to achieve the digital multifunction machine 1 in which for an arbitrary plurality of functions, a print setting button displays a print start button composed of setting buttons on which information indicating various print settings is displayed and when a long-press operation of one of the setting buttons is performed, a print setting screen related to a print setting associated with the one of the setting buttons is displayed by the display 171 to perform setting.

Preferred aspects of the present disclosure also include combinations of any of the aspects described above. In addition to the aforementioned embodiments, the present disclosure may include various modifications. Such modifications should not be construed as falling outside the scope of the present disclosure. The present disclosure should include meanings equivalent to the scope of the claims and all modifications within the scope.

What is claimed is:

1. A display operation device comprising:
an operation acceptor that receives an operation performed by a user;
a display that displays, to the user, a setting screen for a job; and
one or more controllers that control the operation acceptor and the display, wherein
the setting screen has a setting button that is used to receive a setting operation performed by the user and display a setting of the setting operation received, and a job start button that receives an operation performed by the user to start the job is composed of a plurality of the setting buttons.

2. The display operation device according to claim 1, wherein
when the operation acceptor receives a predetermined first operation of one of the setting buttons, the one or more controllers cause the display to display a setting change screen on which a change in setting associated with the one of the setting buttons is received.

3. The display operation device according to claim 2, wherein
the first operation is a predetermined swipe operation of the one of the setting buttons.

4. The display operation device according to claim 2, further comprising
a timer that measures predetermined determination time, wherein
the first operation is a long-press operation of the one of the setting buttons for the determination time or more.

5. The display operation device according to claim 1, wherein
when the operation acceptor receives a predetermined second operation of one of the setting buttons, the one or more controllers cause a job to be performed according to a setting associated with the one of the setting buttons.

6. The display operation device according to claim 5, further comprising
a timer that measures predetermined determination time, wherein
the second operation is a short-press operation of the one of the setting buttons for less than the predetermined determination time.

7. An image forming apparatus comprising:
the display operation device according to claim 1; and
an image former that performs image formation based on a print execution command received by the operation acceptor, wherein
the display displays, to the user, a setting screen related to the image formation, and
the setting screen includes an image formation start button composed of a plurality of setting buttons associated with various respective predetermined image formation settings.
